(19) United States
(12) Patent Application Publication
(10) Pub. No.: US 2008/0240216 A1
(43) Pub. Date: Oct. 2, 2008

(54) Link adaptation method

(75) Inventors: Troels Kolding, Klarup (DK); Klaus Pedersen, Aalborg (DK); Frank Frederiksen, Klarup (DK)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/806,424

(22) Filed: May 31, 2007

(30) Foreign Application Priority Data
Apr. 2, 2007 (FI) 20075223

(51) Int. Cl. H04B 3/00

(52) U.S. Cl. 375/227; 375/E07.002

(57) ABSTRACT

A method, where data is transmitted from a network node to user equipment in a succession of communication frames. An estimate indicative of the quality of the user equipment transmission channel in a reference communication frame is ascertained, and modified by an amount that varies in dependence on a configuration of the resources allocated to the user equipment in the reference communication frame. The modified estimate is used in selecting one or more connection parameters for a data transmission in a target communication frame. This improves the adaptation of the transmission parameters to the existing channel conditions

### FIELD OF THE INVENTION

The present invention relates to telecommunications and more particularly to a link adaptation method for data transmissions.

### BACKGROUND OF THE INVENTION

Communication systems and wireless communication systems in particular, have been under extensive development in recent years. Several new services have been developed in addition to the conventional speech transmission. Different data and multimedia services are attractive to users, and communication systems are expected to provide sufficient quality of service at a reasonable cost.

The new developing services require high data rates and spectral efficiency at a reasonable computational complexity. One proposed solution is to use link adaptation techniques, where transmission parameters such as modulation, coding, and/or transmission power are dynamically adapted to the changing channel conditions. Link adaptation is especially useful if the transmitter has some knowledge about channel state prior to transmission.

One access technique where link adaptation may be used is a multicarrier system. Furthermore, multiple antennas may be employed in transmission and reception. In traditional wireless communication systems a connection transmits on a single frequency. In multicarrier systems each connection may use several carriers, which may be called subcarriers. The use of subcarriers can increase data throughput. Both in transmission and in reception multiple antennas may be used. The use of multiple antennas provides an efficient diversity solution against fading channels. One such system is a MIMO OFDMA system, which combines MIMO (multiple input multiple output) techniques with OFDM (orthogonal frequency division multiplexing) modulation. In OFDM systems link adaptation and user multiplexing may be performed in the frequency domain.

Information about the channel state may be obtained through the signaling of channel quality indication (CQI) reports. In general, a receiver may measure channel condition from a signal it has received and transmit information based on the measurements to the transmitter. The transmitter may utilize the information when selecting transmission parameters. For example, in systems where a base station is connected to user equipment, the user equipment may determine a channel quality indication and send information reports to the base station. Ideally, these reports reflect the channel quality response with a high resolution in both time and frequency domain.

The problem with procedures using such channel estimations is that due to several sources of errors in the transmission path, they are susceptible to bias. In a known method the bias from temporary changes in the time domain have been alleviated in the infrastructure node by complementing the selections of the adaptive coding and modulation with a second control mechanism where link adaptation is provided by comparing the channel estimate to a target value and modifying the ratio between a target value and the channel estimate according to the result of the comparison. One of the ways of performing the modification is scaling the estimate with a scaling factor that changes incrementally with predefined steps according to the success or failure of the transmission. This has enabled performances that are in better adaptation to the actual channel conditions.

This type of modification evolves during successive transmissions, and is thus primarily capable to alleviate the temporal variations in the channel condition. When the frequency domain resolution is introduced to the error estimation and link adaptation, it has been noted that the known methods do not sufficiently compensate the effects of bias.

### BRIEF DESCRIPTION OF THE INVENTION

An object of the present invention is thus to provide a method and an apparatus for implementing the method to improve the adaptation of the transmission parameters to the existing channel conditions.

In an aspect, there is provided a method that comprises transmitting data from a network node to user equipment in a succession of communication frames, a communication channel corresponding to one or more communication frame resources allocated to user equipment in the succession of communication frames; ascertaining an estimate indicative of the quality of the user equipment transmission channel in a reference communication frame; modifying the estimate by an amount that varies in dependence on a configuration of the resources allocated to the user equipment in the reference communication frame; and sing the modified estimate in selecting one or more connection parameters for a data transmission in a target communication frame.

In another aspect, there is provided a network node for a telecommunication system. The network node comprises a transceiver configured to transmit data to user equipment in a succession of communication frames, a communication channel corresponding to one or more communication frame resources allocated to the user equipment in the succession of communication frames, and to ascertain an estimate indicative of the quality of the user equipment transmission channel in a reference communication frame. The network node also comprises a controller configured to modify the estimate by an amount that varies in dependence on the current configuration of the resources allocated to the user equipment in the reference communication frame, and use the modified estimate in selecting one or more connection parameters for a data transmission in a target communication frame.

In another aspect, there is provided a communication system, comprising at least one user equipment and a network node. The network node comprises a transceiver configured to transmit data to user equipment in a succession of communication frames, a communication channel corresponding to one or more communication frame resources allocated to the user equipment in the succession of communication frames, and to ascertain an estimate indicative of the quality of the user equipment transmission channel in a reference communication frame. The network node also comprises a-a controller configured to modify the estimate by an amount that varies in dependence on the current configuration of the resources allocated to the user equipment in the reference communication frame, and use the modified estimate in selecting one or more connection parameters for a data transmission in a target communication frame.

In another aspect, there is provided a computer program distribution medium readable by a computer and encoding a computer program of instructions for executing a computer process for channel quality signaling method between a network node and user equipment in a telecommunication system. The network node and the user equipment communicate with each other through a communications channel, the communication channel corresponding to one or more communication frame resources allocated to the user equipment. The process comprises transmitting data from a network node to user equipment in a succession of communication frames, a communication channel corresponding to one or more communication frame resources allocated to user equipment in the succession of communication frames; ascertaining an estimate indicative of the quality of the user equipment transmission channel in a reference communication frame; modifying the estimate by an amount that varies in dependence on a configuration of the resources allocated to the user equipment in the reference communication frame; and using the modified estimate in selecting one or more connection parameters for a data transmission in a target communication frame.

The invention is based on the idea modifying the estimate received from the user equipment by an amount that varies in dependence on the current configuration of the resources allocated to the user equipment. This additional modification provides a control mechanism that takes into consideration the relatively short-term variations in the frequency domain. Preferably the estimate is also modified in dependence on the responsiveness of the selection of the modulation and coding scheme to the value of the estimate.

### BRIEF DESCRIPTION OF THE DRAWINGS

In the following the invention will be described in greater detail by means of preferred embodiments with reference to the attached drawings, in which

FIG. 1 illustrates a part of a cellular radio system;

FIG. 2 illustrates an exemplary embodiment of an inner loop link adaptation method for adaptive modulation and coding;

FIG. 3 shows a flow diagram of a previously proposed outer loop link adaptation method;

FIG. 4 illustrates expected standard deviation of the CQI estimation error;

FIG. 5 illustrates the steps of a method that corresponds to the exemplary embodiment discussed above; and

FIG. 6 illustrates a simplified example of the structure of a base station.

### DETAILED DESCRIPTION OF SOME EMBODIMENTS

The following embodiments are exemplary implementations of the present invention. Although the specification may refer to “an”, “one”, or “some” embodiment(s), reference is not necessarily made to the same embodiment(s), and/or a feature does not apply to a single embodiment only. Single features of different embodiments of this specification may be combined to provide further embodiments.

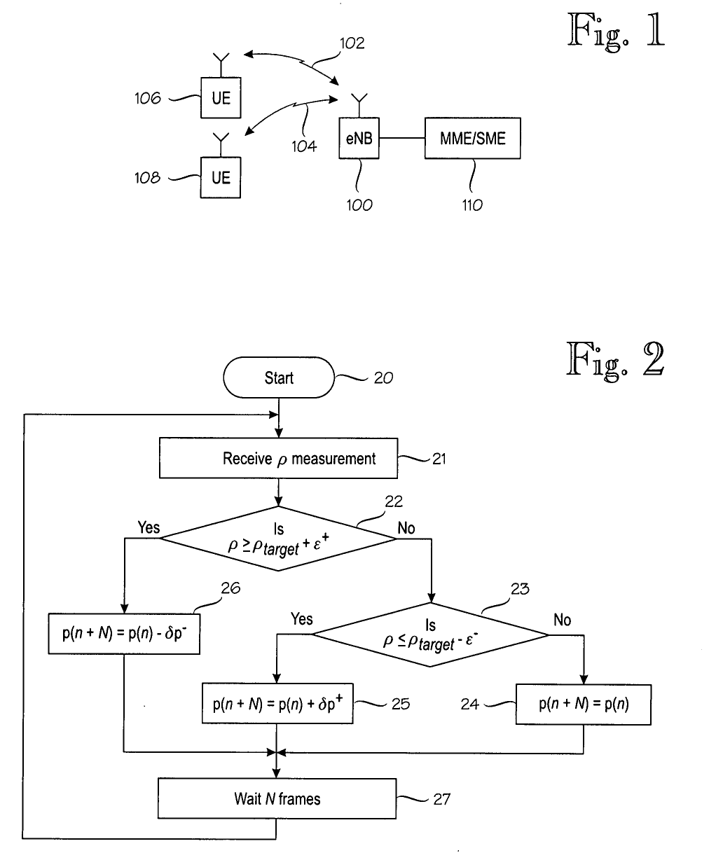

FIG. 1 is a simplified illustration of a digital data communication system to which an embodiment according to the invention is applicable. In FIG. 1, the data communication system is illustrated with the architecture of Evolved Universal Terrestrial Radio Access Network (E-UTRAN) without limiting the scope to the particular standard or by the terms used in describing it. A person skilled in the art can easily apply the instructions to any telecommunication system containing corresponding characteristics.

FIG. 1 illustrates a part of an E-UTRAN cellular radio system, which comprises an E-UTRAN NodeB (eNB) or an equivalent network element 100, which communicates over bi-directional radio links 102 and 104 with user equipment 106 and 108. The user equipment may be fixed, vehicle-mounted or portable. In the E-UTRAN network, eNB is responsible for providing the E-UTRA user plane and control plane protocol terminations towards the user equipment. To achieve this, eNB hosts a variety of functions, including functions for radio resource management, radio bearer control, radio admission control, connection mobility control, and dynamic allocation of resources to user equipment in both uplink and downlink (scheduling). eNB also manages measurement and measurement reporting configuration for mobility and scheduling.

eNBs may be interconnected with each other by means of a X2 interface. eNBs may also be connected by means of a S1 interface to a EPC (Evolved Packet Core). This S1 interface diversifies more specifically to a S1-MME interface towards MME (Mobility Management Entity) and to a S1-U interface towards the System Architecture Evolution (SAE) Gateway. The S1 interface supports a many-to-many relation between MMEs/SAE Gateways and eNBs. MME is responsible for distribution of paging messages to the eNBs, security control, idle state mobility control, SAE bearer control, and ciphering and integrity protection of NAS signalling. The SAE Gateway primarily hosts the functions for termination of user plane packets for paging reasons, and switching of user plane for support of user equipment mobility.

The eNBs may exchange signals with user equipment over the bi-directional links using given resources and given transmission parameters. In systems that employ link adaptation and user multiplexing, the resources and transmission parameters may be dynamically varied on the basis of channel quality estimations provided by the user equipment. Typically, a channel quality estimation is implemented in form of a channel quality indication report that comprises defined data on the channel quality, and a suggestion about transmission parameters with which the user equipment assumes a given transmission quality can be achieved. In order to enable estimation of the channel quality, eNB typically transmits a pilot signal or known pilot symbols with a predefined transmission power. However, the exact methods and quantities used to estimate the channel quality are, as such, not relevant in respect of the embodiments of the invention. The channel quality estimations may be performed using any applicable channel quality reporting method.

In the following, a basic example of a channel quality indication is discussed in more detail in the system of FIG. 1 that employs an orthogonal frequency division multiplexing (OFDM) data transmission scheme.

In the system, eNB may allocate resources to user equipment in time and in frequency domain. In time domain, eNB schedules the users to transmit or receive data at different time intervals. The utilization of OFDM in packet data transmission enables the scheduling to be carried out also in the frequency domain. This means that, at a given time instant, a total frequency band of an OFDM signal is divided into a plurality of frequency blocks (sometimes referred to as physical resource blocks) and the frequency blocks are scheduled to user equipment for data transmission. Each frequency block may be allocated to different user equipment or multiple frequency blocks may be allocated to some user equipment, depending on the radio channel conditions and the network load.

As is commonly known, an OFDM signal consists of a plurality of subcarriers and each subcarrier carries a symbol during an OFDM symbol interval. A frequency block may comprise a plurality, even dozens, of subcarriers. eNB allocates the frequency blocks to the user equipment that receives a packet data service on the basis of channel quality indications (CQls) received repeatedly from the user equipment. The user equipment transmits CQls so that eNB is constantly aware of the channel conditions of the user equipment receiving the packet data service.

Calculation of CQI in the user equipment may be based on a pilot signal that eNB transmits continuously or with a defined scheme on a common pilot channel with a given transmit power level for channel estimation. Other methods known to the person skilled in the art are possible for determination of CQI, for example data assisted methods. Since the telecommunication system utilizes OFDM multicarrier data transmission for the packet data service, eNB may transmit the pilot signal as an OFDM multicarrier signal that covers a frequency range utilized for the packet data service. The pilot signal does not have to be transmitted on every subcarrier of the OFDM multicarrier signal and, therefore, it suffices that the pilot signal is transmitted on given subcarriers having frequency separation that enables estimation of the channel transfer function for proper restoration of the received signal. From this estimation it is also possible to identify which frequencies suffer from fading. The frequency range may be divided into frequency blocks where each frequency block comprises a plurality of subcarriers, as described above. The pilot signal may be transmitted on one or more subcarriers of each frequency block.

The user equipment may have knowledge of the transmit power level eNB uses for the pilot signal. The user equipment that receives the pilot signal may calculate a parameter related to the channel quality from the received pilot signal for each of the frequency blocks. The parameter or channel quality metric may be a signal-to-interference-plus-noise-power ratio (SINR), for example. Instead of SINR, other channel quality metric quantities may be used. For example, the CQI reporting may take the format of indicating a supported data rate given some transmission parameters like modulation and coding scheme under the constraint that the user equipment should guarantee a certain block error rate. Other options, like a user equipment indication on frequency dependent channel attenuation/gain may be used. According to an algorithm known in the art, the channel quality metrics, like SINRs, may be calculated for each frequency block utilizing the pilot signal on the frequency block that the channel quality metric is calculated for.

Link adaptation refers to the process of changing transmission parameters of a communication channel to compensate for the variation in the channel condition. In link adaptation, channel quality indications may be used for several purposes and in various processes. In the following, link adaptation through adaptive modulation and coding is used for illustrating the embodiment without limiting the scope to the particular link adaptation mechanism, transmission parameters or specific terms related therewith.

Adaptive modulation and coding comprises selecting a modulation and coding scheme for transmission. The goal of adaptive modulation and coding is to change the modulation scheme according to the various channel conditions. A user with favorable channel conditions may be assigned higher order modulation with higher code rates, and the opposite is true when the user has unfavorable channel conditions.

The adaptive modulation and coding link adaptation algorithm is applicable for selecting the optimum modulation and coding scheme, as well as some other relevant transmission parameters, depending on the experienced signal-to-interference ratio at the user equipment, given some total transmit power and code constraints. The selection of modulation and coding scheme typically depends on a given ρ=E_{b}/N₀ and a given, fixed error threshold. It has been noted, however, that due to various imperfections in the system, estimation errors etc. the adaptive modulation and coding algorithms typically suffer from bias in the estimation of SIR at the user equipment.

One of the methods proposed to improve the link adaptation is inner loop link adaptation method. In the inner loop link adaptation method the power level ρ allocated to a particular downlink transport channel shared by several user equipment is modified. The aim of the method is to adjust ρ=E_{b}/N₀ to an E_{b}/N₀ target value that corresponds to a desired frame error rate.

FIG. 2 illustrates an exemplary embodiment of an inner loop link adaptation method for adaptive modulation and coding. The method starts with a step 20. In step 21 a ρ=E_{b}/N₀ measurement report is received. This current p value, i.e. the current ρ=E_{b}/N₀ measurement is compared with a small interval around a target value ρ_{target}, where ρ_{target} is the desired channel condition E_{b}/N₀ value that corresponds to the desired frame error rate (FER). In step 22 it is checked whether ρ is larger than or equal to ρ_{target}+ε⁺ where ε⁺ is a predetermined margin parameter that defines the target upper threshold for ρ. If ρ does not exceed ρ_{target}+ε⁺ the method continues in step 23 with checking whether ρ is smaller than or equal to a target lower threshold ρ_{target}−ε⁻. If this is not the case, the power allocated to the transmission channel will be set to the current value for the next N frames in step 24. If, however, ρ is smaller than ρ_{target}−ε⁻ the power allocated to the transmission channel for the next N frames is increased by a first power step δp⁺ in step 25.

In case it is ascertained in step 22 that ρ p is larger than or equal to ρ_{target}+ε⁺ the power ρ allocated to the transmission channel for the next N frames is decreased by a second power step δp⁻ in step 26. From steps 24, 25, 26 the method proceeds with waiting the next N frames to receive the next ρ=E_{b}/N₀ measurement report in step 21. In this alogrithm, the variables ρ_{target}, δp⁻, δp⁺, εp⁺, εp⁻ may be system parameters. The value for ρ_{target} need not be a constant value. The channel condition which gives rise to a particular FER value depends very much upon which modulation and coding scheme are chosen.

Even better results have been obtained by a further adaptation mechanism, hereinafter referred as outer loop adaptation method. The outer loop adaptation method in adaptive modulation and coding is effective in alleviating the bias detected with use of the inner loop link adaptation method. The outer loop adaptation method aims to modify the ratio of the transmission quality estimate and the transmission quality target according to the actual channel condition, and thereby influence the selection of the transmission parameters.

The modification of the ratio may be implemented in various ways, for example by changing the target value, or scaling the present estimate while the target value remains unchanged. It is possible to control the ratio by modifying both the target and the estimate, but such algorithms may be more complicated.

In the following, one exemplary embodiment of the outer loop adaptation method is discussed in more detail. In the embodiment the modification of the ratio is implemented by changing the estimate in a predefined manner. It is assumed that there is a mapping from whatever reported CQI value to an equivalent SINR value, which may be treated in either dB or linear domain. The change may thus comprise multiplying the channel quality estimate with an adjustable scaling factor A. Multiplication by a scaling factor is advantageously applied when the channel quality is expressed in linear form. The change may equally comprise subtracting/adding an adjustable scaling factor to/from the channel quality estimate. Subtraction/addition is advantageously applied when the channel quality is expressed in decibels (dB). The adjusted channel quality estimate may then be used in the inner loop link adaptation algorithm that affects the selection of the transmission parameters.

The outer loop link adaptation algorithm in this embodiment relies on ACK/NACK (Acknowledged/Not acknowledged) responses that the transceiving network node receives for the user equipment. In a downlink session between the user equipment and eNB, the user equipment receives over the radio link packet data units and sends back an ACK or NACK response, depending on whether the packet data unit was properly received.

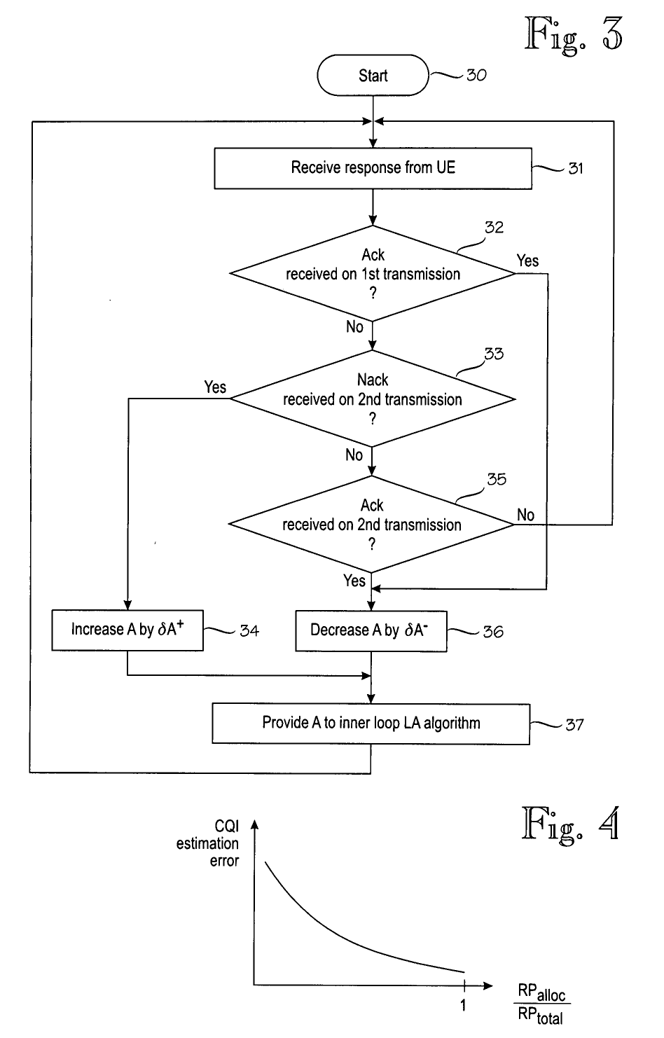

FIG. 3 shows a flow diagram of a previously proposed outer loop link adaptation method. The method starts with a step 30. In step 31 a response on a transmission of a packet data unit is received from the user equipment. In step 31 the response is evaluated. It is checked (step 32) whether an ACK response was received for a packet data unit after a first transmission of this data packet. If yes, the method branches to step 36 in which the scaling factor is reduced by a first scaling step 6δ⁻. The reduced scaling factor A-δA⁻ or the channel quality estimate multiplied with the reduced scaling factor A-δA⁻ may then be provided for use in the inner loop link adaptation method in step 37.

If the result of the evaluation is ‘No’, the evaluation of the response continues in step 33. here it is checked whether a NACK message was received for a packet data unit after a second transmission of this data packet. If Yes, the method branches off to step 34 where the scaling factor is increased by a second scaling step 6δ⁺. The increased scaling factor A+δA⁺ or the channel quality estimate multiplied with the increased scaling factor A+δA⁺ may then be provided for use in the inner loop link adaptation method in step 37.

If the result of the evaluation of step 33 is ‘No’, the evaluation of the response continues in a step 35. It is checked whether an ACK was received for a PDU after the second transmission of this data packet. If Yes, the method branches off to step 36 in which the scaling factor is reduced by a first scaling step δA⁻. The reduced scaling factor A-δA⁻ or the channel quality estimate multiplied with the reduced scaling factor A-δA⁻ may then be provided for use in the inner loop link adaptation method in step 37.

If the answer to the evaluation of step 35 is ‘No’, it means that the response from the receiver was to a third, fourth, or further transmission. In this embodiment, such retransmissions do not lead to an adaptation of the scaling factor A. This means that the method switches back to step 31 to wait for the next response from the receiver.

The procedure of FIG. 3 has been discovered to effectively alleviate the bias in inner loop adaptation method. The problem detected in this type of basic adjustment of the scaling factor is, however, that it is not adequately responsive to the variation of the channel quality estimations in frequency domain. When the variations in other dimensions than time become relevant, the vulnerability to the biasing effect becomes evident. Accordingly, the resource allocation configuration of the user, as well as the total resource allocation configuration of the reference frame may have a considerable biasing effect in the channel quality estimation.

For example, it has been noted that when the amount of resource blocks allocated to user equipment increases, the equivalent CQI error reduces. Assuming each CQI report is subject to zero mean Gaussian error, and the error is uncorrelated between sub-reports, CQI error reduction is an inherent effect that results from averaging the number of CQI sub-reports before transmitting the report to the eNB. The simple graph of FIG. 4 illustrates expected standard deviation of the CQI estimation error as a function of the ratio (RP_{alloc}/RPₜₒₜₐₗ) of the relative number of allocated resources RP_{alloc} and the total available resources RPₜₒₜₐₗ in a frame. It may be seen that the smaller the amount of allocated resources, the greater the probability of error in the estimation. It is clear that in systems where the amount of resource blocks allocated to a user may vary from sub-frame to sub-frame, the decisions on the amount of resource blocks cannot rely on an estimate that is only adjusted on the basis of long-term extracted bias value, which is insensitive to the variations in the allocated resources in the reference frame.

Furthermore, scheduling methods are differently affected by errors in the estimations. Scheduling methods that substantially do not take into account the channel quality estimations in their scheduling decisions, for example round-robin and blind scheduling schemes, are substantially not affected by estimation errors but, on the other hand, are associated with considerably less throughput performance. With a scheduler that does round-robin or blind scheduling in time and frequency, one expects to measure resource blocks with significant but zero-biased error associated with them. On the other hand, scheduling methods that are more or less responsive to the channel quality estimations in their scheduling decisions, for example radio-aware or opportunistic packet scheduling, are not expected to operate well if the different effect of different scheduling methods is not considered at all.

It is understood that when the amount of user equipment scheduled for a subframe is low, the effect of bias is smaller, but when the amount of user equipment increases, the effect of bias becomes more disruptive. A scheduler that does radio-aware or opportunistic packet scheduling in time and frequency expectedly prefers in its selections resource blocks that, according to their channel quality estimates, provide the best SIR or Signal to Interference-plusNoise Ratio (SINR). However, the high SINR value may be correct or a result of a CQI error. If the latter case, for example, when two user equipment have the same SINR in some frequency band, the SINR measurement error becomes decisive in judging which one gets scheduled. If the estimate is positive, i.e. the user equipment provides erroneous, overestimated SINR, it takes precedence in scheduling. According to frequency domain packet scheduling simulations the CQI error may get biased up to 1.0-1.5 dB When a relatively high amount of users are active simultaneously.

Such problems may be alleviated by a dynamic outer loop adaptation method. In the known solution of FIG. 3 the rate of change, for example the size of the steps used for adjusting the scaling factor, were fixed parameters to be preset in radio network planning. In such case the adjustment of the scaling factor starts from a defined point, and evolves incrementally in line with results from success of transmissions towards a scaling factor that corresponds with the current bias.

In the improved method, the convergence towards the desired value is enhanced by using a dynamically adjustable increment. This increment is advantageously determined in dependency of the configuration of the resource allocation. Configuration herein represents a combination of one or more parameters that may be used to characterize the user resource in the selected multiple access scheme. The increment is advantageously also determined in dependency of responsiveness of the applied packet scheduling method to estimations of the channel quality. This improved method provides a further adjustment procedure that takes into consideration the physical effects that cause the bias to change rapidly, even between subframes.

In the following, an embodiment of the improved, dynamic outer loop adaptation method is described in more detail. The embodiment is based on the terms and concepts introduced with the known solutions of FIGS. 2 and 3. In the inner loop adaptation method the channel quality estimate userCQI(k) used for scheduling decisions concerning user equipment k is derived from:

userCQI(k)=CQI(k)+Offset(k)

where CQI(k) is the channel quality estimate as received from the user equipment, and Offset(k) is now the scaling factor provided by the dynamic outer loop adaptation algorithm to the inner loop. Offset(k) represents here a dynamic factor that advantageously comprises a gradually evolving element and a dynamically adjustable element that in the end both contribute to the value that is provided to inner loop adaptation algorithm. It is clear to the person skilled in the art that the equations here are exemplary and may be varied in many ways to formalize the similar dynamically adjustable effect.

The adjustment may be based on converging towards a desired adaptation value. In the embodied solution, the communication channel of user equipment corresponds to one or more resource blocks allocated to the user equipment in the succession of subframes. For a target subframe for which the outer loop adaptation method is performed, there is a reference frame that may be used as a basis for the decisions made in the dynamic outer loop algorithm. The reference frame may be defined in various ways, depending on the application. In the embodied example, the reference frame is a predefined previous subframe that corresponds to the CQI report received from the user, and the target frame is the next subframe for which the transmission parameters are to be determined.

In the dynamic outer loop adaptation method, for all users that are allocated to a reference subframe and for which the ACK/NACK report has been received, the dynamic scaling factor can be derived as:

Offset(k)=FUNC[ACK/NACK,NumRB(k),PS_{—}info,Offset(k)]

where FUNC represents an application specific equation or algorithm that maps a given group of input parameters into a value that can be provided to a procedure that may have effect on the link adaptation, for example the inner loop adaptation method. The input parameters comprise at least one parameter whose value varies in dependence of the configuration of the resource allocation, and advantageously at least one parameter whose value varies in dependence of the responsiveness of the scheduling algorithm to the channel quality estimation.

In the illustrated example, the input parameter ACK/NACK represents the parameter, whose value changes in dependence of success or failure of the previous transmission, and Offset(k) represents the parameter whose value stores the previous value for the scaling factor. These illustrate the parameters that enable the gradually evolving change of the scaling factor towards the desired value. The value of Offset(k) is changed incrementally according to the successive values of ACK/NACK.

Furthermore, NumRB(k) represents a parameter whose value varies in dependence of the configuration of the allocated resource. In the example the parameter used is the number of resource blocks currently allocated for the user equipment. PS_info represents a parameter whose value varies in dependence of the responsiveness of the current scheduling algorithm to the channel quality estimation. For a person skilled in the art it is clear that other parameters may be used to provide the required frequency and/or scheduler operation dependency without deviating from the scope of protection.

In the following, an exemplary embodiment of an algorithm for implementing the function FUNC is provided in pseudo coded form. In this embodiment PS_info is implemented as a parameter whose value stores the current indication that reveals to which extent the scheduler in the reference transmission followed the recommendation it received in the CQI from the user equipment. For example, PS_info may be arranged to be positive if the recommendation was followed, which implies that the scheduler is responsive to the channel quality indication. Correspondingly, PS_info is then arranged negative if the recommendation was not followed, and this implies that the scheduler is not responsive to the channel quality indication. It is clear that the type of indication is an example and as such is not relevant; for example values varying between 0 . . . 1 according to the level of similarity between the performed allocation and the allocation estimated by the user equipment. Furthermore, res(ACK/NACK) represents a parameter whose value indicates whether the previous transmission was successful (ACK) or failed (NACK).

In the embodied example, the dynamic scaling factor is derived as

Offset(k)=Offset_{—}OL+DynOffset_{—}OL

where Offset_OL corresponds to the scaling factor that is known from the above outer loop adaptation method of FIG. 3, and DynOffset_OL corresponds to the dynamic factor that is arranged to take into consideration the frequency and bandwidth variations in the channel estimations.

The embodied dynamic outer loop adaptation method is configured with a group of one or more initial dynamic factor values DynOffset_OL(RB), each of which corresponds to a particular resource block configuration RB. For each user, the initial dynamic factor value is chosen on the basis of the allocated resource block configuration, here the number of resource blocks allocated for the user. For simplicity, in the embodied example two initial dynamic factor values are used: DynOffset_OL_{RB1} that corresponds to the first range and DynOffset_OL_{RB2} that corresponds to the second range of values for the number of allocated resource blocks. For a person skilled in the art it is naturally straightforward to apply the same principle to any additional number of values.

```
IF NumRB ε Range1
        DynOffset_OL=DynOffset_OL_{RB1}
ELSE
        DynOffset_OL=DynOffset_OL_{RB2}
END
IF PS_info=positive
        scale1=1,0
ELSE
        scale1=0,1
END
IF res(ACK/NACK)=NACK
        Offset_OL=Offset_OL+stepDown
        DynOffset_OL=DynOffset_OL+dynStepDown*scale1
ELSE
        Offset_OL=Offset_OL+stepUp
        DynOffset_OL=DynOffset_OL+dynStepUp*scale1
END
```

stepUp and stepDown and predefined values that correspond with the scaling step of the method in FIG. 3. dynStepUp and dynStepDown are new variables, preferably implemented as predefined values.

It should be noted that in the embodied example the values of Offset_OL and DynOffset_OL are adjusted at the same time and for a single user. It is clear that the adjustment could be done separately, as well.

It is understood that the introduction of DynOffset_OL element allows dynamic adjustment of the scaling factor, which through use of initial dynamic factor values DynOffset_OL(RB) is responsive to the amount of resources allocated to the user and through use of scale1 influences to the adjustment of the scaling factor according to the determined behavior of the scheduler. In the embodied example, this allows an improved adaptation of the inner loop algorithm, and thus alleviates the effects of bias in decisions for transmission parameters, like adaptive modulation and coding, or the selection of the physical resource blocks for the user equipment for the transmission. It is appreciated that in addition to the new dynamic effect introduced by the DynOffset_OL element, the embodied algorithm also encompasses the known evolving adjustment in the time dimension.

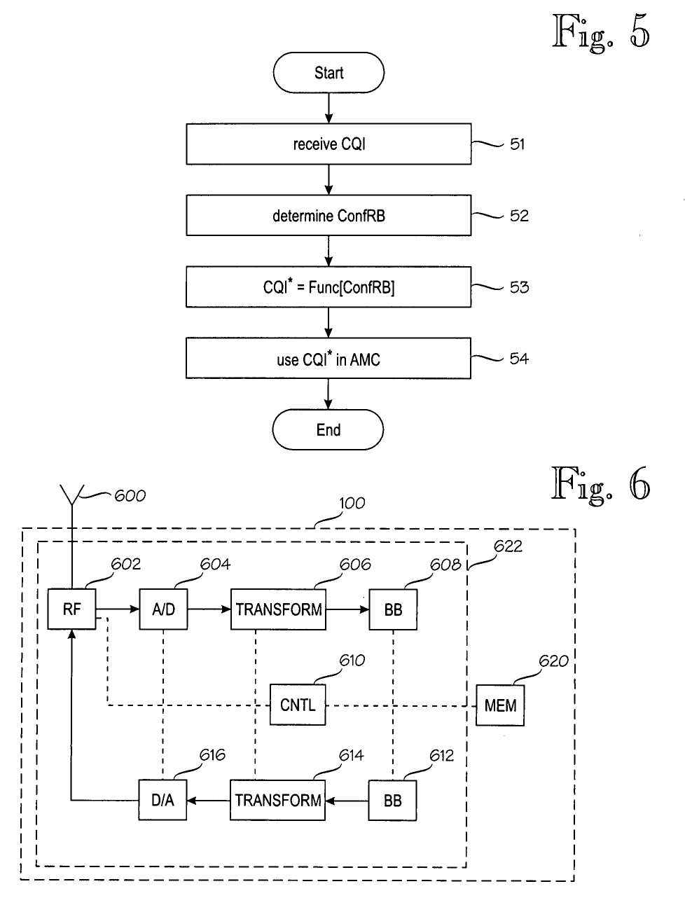

FIG. 5 illustrates the steps of a method that corresponds to the exemplary embodiment discussed above. The method starts with a step 50. In step 51 an estimate on the transmission channel condition is received from the user equipment. In step 52 the configuration of the resource ConfRB allocated for the user equipment in a reference communication frame is determined. In step 53 a modified channel quality estimate CQI* is determined as a function FUNC of the resource ConfRB. As discussed above, the function FUNC is advantageously also dependent on the responsiveness of the packet scheduling algorithm to the transmission channel estimates provided by the user equipment. In step 54 the modified channel condition estimate CQI* is used in selection of transmission parameters, advantageously as an input parameter to an inner loop adaptation algorithm, which is used, for example, to adjust the selection of modulation and coding schemes for the transmission, or the selection of the physical resource blocks for the user equipment for the transmission.

FIG. 6 illustrates a simplified example of the structure of a network node, like eNB 100 applicable in a telecommunication system employing OFDM. The network node comprises a transceiver 622 that is configured to communicate with user equipment of the system using a set of given resources. The transceiver comprises an antenna 600, which receives a signal transmitted by the user equipment. The received signal is filtered and amplified in an RF block 602 and converted into a digital form in an A/D converter 604. The signal is further taken to a transformer 606, where the received signal is converted into frequency domain. The number of signals in the output of the transformer 606 equals the number of used ODFM subcarriers. The signals are taken to base band parts 608 of the transceiver and then to processing according to protocols applicable to each of the signals.

On the transmitter side of the transceiver, the signal to be transmitted is taken from base band parts 612 to a transformer 614, where the signal is converted into time domain. From the transformer, the signal is taken to a D/A converter 616, where the signal is converted to an analog form, taken to the RF block 602 to be amplified, filtered and transmitted using the antenna 600.

In the present embodiment the transceiver configured to transmit data to user equipment in a succession of communication frames. A communication channel corresponds to one or more communication frame resources allocated to the user equipment in the succession of communication frames. The transceiver also ascertains an estimate indicative of the quality of the user equipment transmission channel in a reference communication frame;

The network node may further include a controller 610, a memory 620, and computer programs for executing computer processes. The memory may be configured to store parameter values for determining the extent of modification, for example the offset values, necessary for adapting the channel condition estimate.

The controller 610 controls the operation of network node, and it may be configured to modify the estimate by an amount that varies in dependence on the current configuration of the resources allocated to the user equipment in the reference communication frame. The controller may also use the modified estimate in selecting one or more connection parameters for a data transmission in a target communication frame. Advantageously, the use comprises providing the modified channel condition estimate as an input parameter to an inner loop adaptation algorithm, which adjusts the selection of modulation and coding schemes for the transmission.

The embodiments of the invention may be implemented as computer programs in the network node. The computer programs comprise instructions for executing a computer process for link adaptation method between a network node and user equipment in a telecommunication system, where the network node and user equipment communicate with each other using a set of given resources. The process comprises transmitting data from a network node to user equipment in a succession of communication frames, a communication channel corresponding to one or more communication frame resources allocated to user equipment in the succession of communication frames; ascertaining an estimate indicative of the quality of the user equipment transmission channel in a reference communication frame; modifying the estimate by an amount that varies in dependence on a configuration of the resources allocated to the user equipment in the reference communication frame; and using the modified estimate in selecting one or more connection parameters for a data transmission in a target communication frame.

The computer programs may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

It will be obvious to a person skilled in the art that, as the technology advances, the inventive concept can be implemented in various ways. The invention and its embodiments are not limited to the examples described above but may vary within the scope of the claims.

1. A method, comprising:
transmitting data from a network node to a user equipment in a succession of communication frames, a communication channel corresponding to one or more communication frame resources allocated to the user equipment in the succession of communication frames;
ascertaining an estimate indicative of a quality of a user equipment transmission channel in a reference communication frame;
modifying the estimate by an amount that varies in dependence of a configuration of the resources allocated to the user equipment in the reference communication frame;
using the modified estimate in selecting one or more connection parameters for a data transmission in a target communication frame.

2. The method according to claim 1, further comprising:
ascertaining the estimate in form of a channel quality indication received from the user equipment.

3. The method according to claim 1, further comprising:
selecting a modulation and coding scheme for the data transmission in the target communication frame using the modified estimate.

4. The method according to claim 1, further comprising:
allocating the communication frame resources for the data transmission in the target communication frame using the modified estimate.

5. The method according to claim 1, wherein the modifying of the estimate further comprises determining a scaling factor and adjusting the estimate with the scaling factor.

6. The method according to claim 5, further comprising:
selecting an initial value of the scaling factor in dependence on a current configuration of the resources allocated to the user equipment.

7. The method according to claim 6, further comprising:
selecting the initial value of the scaling factor in dependence on a number of resource blocks allocated to the receiver.

8. The method according to claim 7, further comprising:
changing the initial value of the scaling factor such that a rate of change varies in dependence on the responsiveness of the selection of the connection parameters to the value of the estimate.

9. The method according to claim 8, further comprising:
changing the initial value of the scaling factor incrementally such that the size of the increment is selected from a number of predetermined sizes of increments in dependence on the responsiveness of the selection of the connection parameters to the value of the estimate.

10. The method according to claim 9, further comprising:
receiving a response from the receiver to a data transmission in the reference communication frame, said response indicating whether the data is received free of errors by the receiver;
evaluating the response; and
performing the incrementing of the initial value of the scaling factor in dependence on the result of the evaluation of the response.

11. A network node for a telecommunication system, the network node comprising:
a transceiver configured to
transmit data to a user equipment in a succession of communication frames, a communication channel corresponding to one or more communication frame resources allocated to the user equipment in the succession of communication frames, and
ascertain an estimate indicative of a quality of a user equipment transmission channel in a reference communication frame; and
a controller configured to
modify the estimate by an amount that varies in dependence of a current configuration of the resources allocated to the user equipment in the reference communication frame, and
use the modified estimate in selecting one or more connection parameters for a data transmission in a target communication frame.

12. The network node according to claim 11, wherein the transceiver is configured to ascertain the estimate in a form of a channel quality indication received from the user equipment.

13. The network node according to claim 11, wherein the controller is configured to select a modulation and coding scheme for the data transmission in the target communication frame using the modified estimate.

14. The network node according to claim 11, wherein the controller is configured to allocate the communication frame resources for the data transmission in the target communication frame using the modified estimate.

15. The network node according to claim 11, wherein the controller is configured to modify the estimate by determining a scaling factor and adjusting the estimate with the scaling factor.

16. The network node according to claim 15, wherein the controller is configured to select an initial value of the scaling factor in dependence on the current configuration of the resources allocated to the user equipment.

17. The network node according to claim 16, wherein the controller is configured to select the initial value of the scaling factor in dependence on the number of resource blocks allocated to the receiver.

18. The network node according to claim 17, wherein the controller is configured to change the initial value of the scaling factor such that a rate of change varies in dependence on a responsiveness of the selection of the connection parameters to a value of the estimate.

19. The network node according to claim 18, wherein the controller is configured to change the initial value of the scaling factor incrementally such that a size of the increment is selected from a number of predetermined sizes of increments in dependence on the responsiveness of the selection of the connection parameters to the value of the estimate.

20. A communication system, comprising at least one user equipment and a network node, comprising:
a transceiver configured to
transmit data to a user equipment in a succession of communication frames, a communication channel corresponding to one or more communication frame resources allocated to the user equipment in the succession of communication frames, and
ascertain an estimate indicative of a quality of a user equipment transmission channel in a reference communication frame; and
a controller configured to
modify the estimate by an amount that varies in dependence of a current configuration of the resources allocated to the user equipment in the reference communication frame, and
use the modified estimate in selecting one or more connection parameters for a data transmission in a target communication frame.

21. A computer program embodied on a computer readable medium, the computer program being configured to control a processor to perform a channel quality signaling method between a network node and a user equipment in a telecommunication system, the process comprising:
transmitting data from the network node to the user equipment in a succession of communication frames, a communication channel corresponding to one or more communication frame resources allocated to the user equipment in the succession of communication frames, wherein the network node and the user equipment communicate with each other through the communications channel, the communication channel corresponding to the one or more communication frame resources allocated to the user equipment;
ascertaining an estimate indicative of a quality of the user equipment transmission channel in a reference communication frame;
modifying the estimate by an amount that varies in dependence on a configuration of the resources allocated to the user equipment in the reference communication frame; and
using the modified estimate in selecting one or more connection parameters for a data transmission in a target communication frame.

22. A network node for a telecommunication system, the network node comprising:
transceiver means for
transmitting data to a user equipment in a succession of communication frames, a communication channel corresponding to one or more communication frame resources allocated to the user equipment in the succession of communication frames, and
ascertaining an estimate indicative of a quality of a user equipment transmission channel in a reference communication frame; and
controller means for
modifying the estimate by an amount that varies in dependence of a current configuration of the resources allocated to the user equipment in the reference communication frame, and
using the modified estimate in selecting one or more connection parameters for a data transmission in a target communication frame.
